(19) United States
(12) Patent Application Publication
(10) Pub. No.: US 2017/0336874 A1
(43) Pub. Date: Nov. 23, 2017

(54) METHOD AND APPARATUS FOR PROCESSING HAND GESTURE COMMAND FOR MEDIA-CENTRIC WEARABLE ELECTRONIC DEVICE

(71) Applicants: INSIGNAL Co., Ltd., Seoul (KR); Industry-University Cooperation Foundation of Korea Aerospace University, Goyang-si (KR)

(72) Inventors: Sung Moon CHUN, Suwon-si (KR); Hyun Chul KO, Jeju-si (KR); Jae Gon KIM, Goyang-si (KR); An Na YANG, Guri-si (KR)

(73) Assignees: INSIGNAL Co., Ltd., Seoul (KR); Industry-University Cooperation Foundation of Korea Aerospace University, Goyang-si (KR)

(21) Appl. No.: 15/597,969

(22) Filed: May 17, 2017

(30) Foreign Application Priority Data
May 20, 2016 (KR) 10-2016-0062260
Sep. 29, 2016 (KR) 10-2016-0125829

(51) Int. Cl. G06F 3/01

(52) U.S. Cl. CPC G06F 3/017; G06F 3/014

(57) ABSTRACT

Disclosed are a method and apparatus for processing a hand gesture command for a media-centric wearable electronic device in an Internet of Media Things and Wearables (IoMTW) system. The processing method according to an embodiment includes acquiring a hand image of a user, distinguishing a background area and a hand area in the acquired hand image, detecting a hand shape using the distinguished hand area and generating hand contour information describing the detected hand shape, detecting a hand movement path based on a change of the distinguished hand area over time and generating hand trajectory information describing the detected hand movement path, and recognizing a hand gesture of the user using the hand contour information and the hand trajectory information.

### CROSS-REFERENCE TO RELATED APPLICATION(S)

This application claim priority from Korean Patent Application Nos. 10-2016-0062260, filed on May 20, 2016 and 10-2016-0125829, filed on Sep. 29, 2016, in the Korean Intellectual Property Office, the disclosure of which is incorporated herein by reference in its entirety.

### BACKGROUND

### 1. Field

The following description relates to a technology that utilizes media-centric wearable electronic devices, and more particularly, to a technology that recognizes a hand gesture of a user with a wearable electronic device and controls the wearable electronic device on the basis of the recognized hand gesture so that multimedia content may be easily consumed.

### 2. Description of Related Art

Recently, along with the wide use of portable electronic devices such as smartphones or tablet computers, wearable electronic devices such as smart clothing, smart bands, smart watches, and smart glasses are being increasingly widely used. A wearable electronic device is a device that may be directly worn by a user or that may be embedded in clothing worn by a user. A wearable electronic device refers to a device that is connected to a network directly or via another electronic device (e.g., a smart phone) and capable of communication. A media-centric wearable electronic device refers to a wearable electronic device with a function of enabling a user to easily control consumption of multimedia content that is displayed on a display of a smart electronic device, such as a watch screen or an eyeglass lens.

Wearable electronic devices have unique characteristics depending to their uses. For example, a wearable electronic device having a camera (e.g., smart glasses, smart clothing, or smart caps) may naturally capture a photo or video in the direction of where a wearer's gaze, body, or head is directed. In particular, smart glasses are easily equipped with a binocular stereo camera due to their structural characteristics. In this case, smart glasses can acquire a stereoscopic image, similar to what a user actually sees. For wearable electronic devices, a method of recognizing a user gesture, for example, a hand gesture with a camera installed therein and regarding the recognized hand gesture as a user command is also considered in addition to voice recognition technology.

However, wearable electronic devices may have some limitations due to their shape, size, material, use, and wearing position. For example, most wearable electronic devices such as smart glasses do not include a keyboard. It is assumed that wearable electronic devices are generally used while a user is moving or does other work with his or her hands. Also, it is preferable to minimize the generation of heat or electromagnetic waves in consideration of the influence of a wearable electronic device on a user's health.

Accordingly, there is a need for a new technology that can process a hand gesture command for a media-centric wearable electronic device in order to sufficiently utilize the above-described characteristics of wearable electronic devices and also overcome several limitations caused by their unique characteristics.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a method and apparatus for processing a hand gesture command for a media-centric wearable electronic device that may control inputting or playing of multimedia content that is displayed on a screen while there is no keyboard and also both hands of a user are free.

The following description also relates to a method and apparatus for processing a hand gesture command for a media-centric wearable electronic device that may be utilized in various application fields.

In one general aspect, a method of processing a hand gesture command for a media-centric wearable electronic device in an Internet of Media Things and Wearables (IoMTW) system includes acquiring a hand image of a user' hand; distinguishing a background area and a hand area in the acquired hand image; detecting a hand shape using the distinguished hand area and generating hand contour information describing the detected hand shape; detecting a hand movement path based on a change of the distinguished hand area over time and generating hand trajectory information describing the detected hand movement path; and recognizing a hand gesture of the user using the hand contour information and the hand trajectory information.

The hand contour information may be expressed as a set of coordinates indicating a plurality of points corresponding to a contour of the detected hand shape or a set of direction vectors of a plurality of fingers constituting the hand.

The generating of hand contour information may include generating the hand contour information only when a movement distance or average movement speed of the hand is greater than or equal to a predetermined reference.

The hand trajectory information may include the hand movement path configured in a time division method, a motion division method, or a point division method.

Metadata for the media-centric wearable electronic device may be composed of a data element, a command element, a media-centric Internet of things (IoT) element, a media-centric wearable element, a processing element, and a user element as top level description elements, and the hand contour information and the hand trajectory information may be included in processing data of the data element. The top level description elements may be generated as needed, and a plurality of the same elements may be generated.

In another general aspect, an apparatus for processing a hand gesture command for a media-centric wearable electronic device in an Internet of Media Things and Wearables (IoMTW) system includes a gesture detection unit configured to distinguish a background area and a hand area in a hand image of a user that is input, detect a hand shape using the distinguished hand area, generate hand contour information describing the detected hand shape, detect a hand movement path based on a change of the distinguished hand area over time, and generate hand trajectory information describing the detected hand movement path; and a gesture recognition unit configured to recognize a hand gesture of the user using the hand contour information and the hand trajectory information delivered from the gesture detection unit.

The hand contour information may be expressed as a set of coordinates indicating a plurality of points corresponding to a contour of the detected hand shape or a set of direction vectors of a plurality of fingers constituting the hand, and the hand trajectory information may have the hand movement path configured in a time division method, a motion division method, or a point division method.

Other features and aspects will be apparent from the following detailed description, the drawings, and the claims.

### BRIEF DESCRIPTION OF THE DRAWINGS

FIG. 1 is a block diagram showing an Internet of Media Things and Wearables (IoMTW) system disclosed in an international standard for IoMTW.

FIG. 2 is a flowchart showing a method of processing a hand gesture command for a media-centric wearable electronic device according to an embodiment of the present invention.

FIG. 3 is a view showing an example in which a detected hand shape is displayed.

FIG. 4A is a view showing an example in which a predetermined specific point Ψ is used as a center point of a hand.

FIG. 4B is a view showing an example in which a point at which direction vectors of fingers join is used as a center point of a hand.

FIG. 5 is a diagram schematically showing an example in which hand position information is managed in the form of a queue.

FIG. 6 is a view showing an example of a hand trajectory that is expressed using a three-dimensional curve.

FIG. 7 is a view showing a difference in hand trajectory due to a difference in average hand movement speed.

FIG. 8 is a diagram schematically showing various hand trajectories.

FIG. 9 is a block diagram showing a schematic configuration of an apparatus for processing a hand gesture command for a media-centric wearable electronic device according to an embodiment of the present invention.

FIG. 10 is a diagram schematically showing an example of a processing process of a hand detection module and a hand recognition module.

FIG. 11A to 11C are diagrams schematically showing examples of a method of configuring one hand trajectory. FIG. 11A is an example of configuring a hand trajectory in a time division method, FIG. 11B is an example of configuring a hand trajectory in a motion division method, and FIG. 11C is an example of configuring a hand trajectory in a point division method.

FIG. 12 is a diagram showing a description structure of metadata for a media-centric wearable device.

FIG. 13 is a diagram showing a configuration of a data element Data in the description structure of FIG. 12 in detail.

FIG. 14 is a diagram showing an example of a configuration of a hand gesture data type HandGestureType in the configuration of FIG. 13.

FIG. 15 is a diagram showing an example of a configuration of a hand contour data type HandContourType in the configuration of FIG. 14.

FIG. 16 is a diagram showing an example of a detailed configuration of a group Bezier curve data type GroupBezierCurveType in the configuration of FIG. 15.

FIG. 17 is a diagram showing an example of a configuration of a hand trajectory data type HandTrajectoryType in the configuration of FIG. 14.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Details of example embodiments are included in the detailed description and drawings. Advantages and features of the described technique, and implementation methods thereof will be clarified through following embodiments described with reference to the accompanying drawings. Like reference numerals refer to like elements throughout.

Relational terms such as “first,” “second,” and the like may be used for describing various elements, but the elements should not be limited by the terms. These terms are used only to distinguish one element from another. As used herein, the singular forms “a,” “an,” and “the” are intended to include the plural forms as well, unless the context clearly indicates otherwise. Furthermore, when one part is referred to as “comprising (or including or having)” other elements, it should be understood that it can comprise (or include or have) only those elements, or other elements as well as those elements unless specifically described otherwise. Moreover, each of terms such as “unit” and “module” used herein denotes an element for performing at least one function or operation, and may be implemented in hardware, software or a combination of hardware and software.

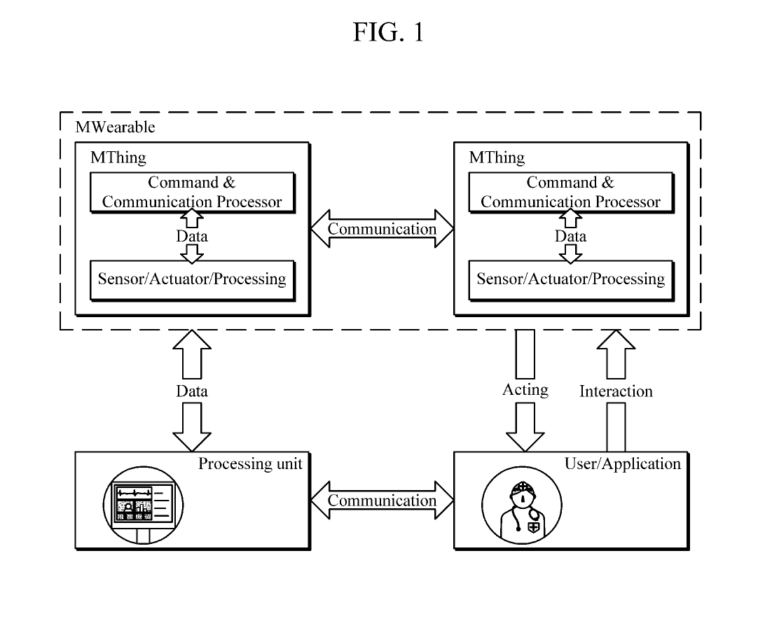

FIG. 1 is a block diagram showing an Internet of Media Things and Wearables (IoMTW) system disclosed in an international standard for IoMTW that is discussed in ISO/IEC SC29/WG11 (MPEG). Referring to FIG. 1, the IoMTW system includes a media wearable electronic device MWearable including one or more media things MThings, a user using an application User/Application and a processing unit Processing Unit. Here, a media thing MThing refers to a thing capable of one or more of audio sensing, video sensing, and actuating. A media wearable electronic device MWearable refers to a wearable device capable of one or more of media communication and storage.

It is required by such an IoMTW system to control a wearable electronic device so that multimedia content may be consumed even when a user's hands are free. To this end, the media wearable electronic device Mwearable may receive a non-contact input such as a hand gesture and/or voice from a user and may control consumption of multimedia content in response to the received non-contact input. Various sensors that detect several types of signals or situations may be needed as elements of the media thing MThing.

In more detail, the wearable electronic device Mwearable may be a device that performs functions of detecting a hand gesture of a user, converting the detected hand gesture into hand representation data having a predetermined format, sending the hand representation data to the processing unit, and controlling multimedia content according to a gesture command received from the processing unit. The processing unit may recognize a hand gesture using a series of hand representation data received from the wearable electronic device and also may output a gesture command corresponding to the received hand gesture to the wearable electronic device. The processing unit may be implemented as a function of a server or host that is disposed outside the wearable electronic device. However, the above-described functional separation between the wearable electronic device and the processing unit is merely illustrative. Accordingly, some functions of any one (e.g., the wearable electronic device) may be replaced with a function of the other (e.g., the processing unit).

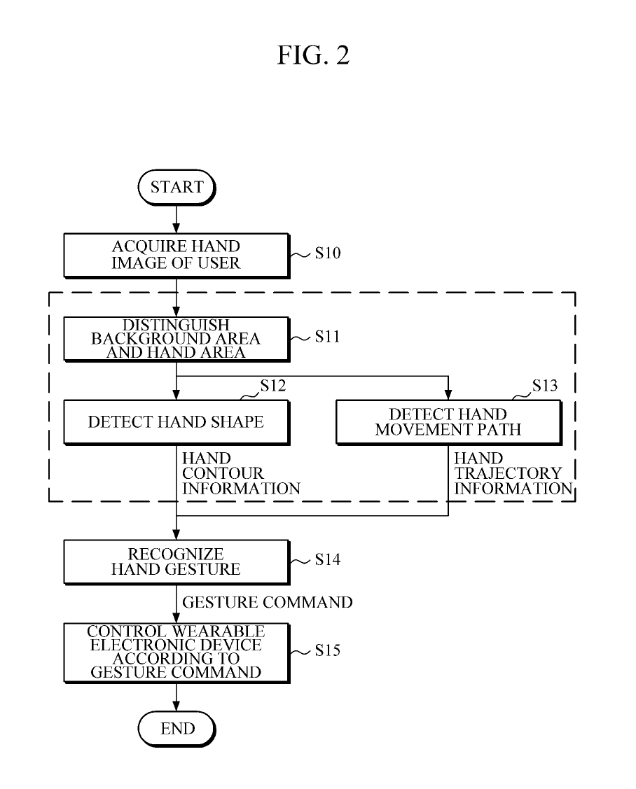

FIG. 2 is a flowchart showing a method of processing a hand gesture command for a media-centric wearable electronic device according to an embodiment of the present invention. The hand gesture command processing method shown in FIG. 2 may be performed in the IoMTW system shown in FIG. 1. However, there are no restrictions on an implementation method thereof. For example, the hand gesture command processing method may be implemented through an integrated function of the wearable electronic device and the processing unit that constitute the IoMTW system or a single function of the wearable electronic device or the processing unit.

Referring to FIG. 2, the IoMTW system, for example, a wearable electronic device acquires a hand image of a user (S10). Here, the hand image is an image including the user's hand, which is not limited to a stereoscopic image. The hand image may be a monoscopic image. In this step, there are no restrictions on a detailed method in which the wearable electronic device acquires an image. For example, the wearable electronic device may directly capture a hand image of a user with a predetermined camera included therein or may receive an image captured by another device.

Also, in step S10, the wearable electronic device acquires an image sequence for a predetermined time, that is, a series of hand images. This is because a hand gesture is represented as a shape and/or motion of a hand for a predetermined time. That is, a hand gesture is not limited to a change in position of a hand in a space with the lapse of time, and may include a change in shape of a hand.

According to an embodiment, the hand image acquired in step S10 may be a stereoscopic image captured with a stereoscopic camera. A stereoscopic camera refers to a pair of cameras, that is, a left camera and a right camera which are spaced a predetermined distance from each other. Since a subject can be imaged by using a stereoscopic camera as if actually seen with both eyes of a user, a natural stereoscopic image, that is, an image pair composed of a left image and a right image may obtained at one time.

In this case, the hand image may additionally include a depth map image captured with a depth camera. A depth camera refers to a camera that may acquire data on a distance to a subject by emitting light such as infrared (IR) rays to the subject. When such a depth camera is used, it is possible to directly obtain depth information, that is, a depth map of a subject. However, a light source such as a light emitting diode (LED) that may emit IR is additionally needed, and also the light source has large power consumption.

Also, the IoMTW system, for example, the wearable electronic device or the processing unit distinguishes a background image and a hand image in the hand image acquired in step S10 (S11). The distinguishing between the background image and the hand image may be implemented in various methods. For example, the wearable electronic device applies a stereo matching method to each of the series of stereoscopic images acquired in step S10 to create a depth map. A depth map refers to data that represents a distance between a camera unit and a subject using a predetermined value. A depth map image may be created by displaying the created depth map in grayscale, and then a background area and a hand image may be distinguished in the depth map image.

There are no restrictions on an algorithm used to separate the hand area and the background area. The hand area and the background area may be separated by considering there is a vacant space therebetween. In this case, by using the vacant space as a boundary value, the hand area and the background area may be separated. Alternatively, by using a property in which a distance from a camera to a user's hand cannot but be limited within a certain range, the hand area and the background area may be separated. In this case, an area having a distance within a predetermined range may be regarded as the hand area, and the other area may be regarded as the background area.

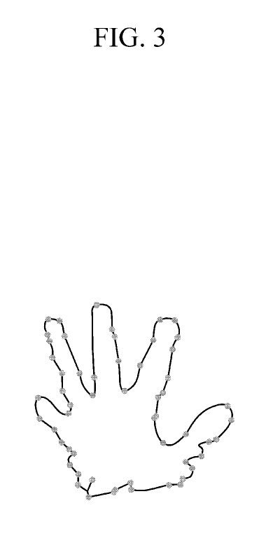

Subsequently, the IoMTW system, for example, the wearable electronic device or the processing unit detects a hand shape on the basis of a contour of the hand area (S12). The term “hand shape” refers to a detailed shape of a hand. For example, whether each finger is extended or folded, how many fingers are extended, or a direction vector indicating in which direction an extended finger points may be used to specify the hand shape. FIG. 3 shows an example in which the detected hand shape is displayed. In this case, the contour of the hand is represented as a group of points.

There are no restrictions on an interval at which the hand shape is detected in step S12. For example, the detection may be performed on each frame image constituting a hand image sequence or performed on some frame images at predetermined intervals (e.g., every 10 frames). Alternatively, depending on embodiments, the detection of the hand shape may be performed only one time. In this case, a command using a hand gesture may consider only a hand movement path as well as a specific hand shape, instead of a change in hand shape over time.

The detected hand shape may be represented as hand contour information having a predetermined format. As an example, the hand contour information may be represented as points shown in FIG. 3, that is, a set of coordinates that indicate the points. As another method, the hand contour may be represented using a direction vector of each finger. In this case, the hand contour information includes a set of the direction vectors. The hand contour information may be utilized as information for recognizing a hand gesture in the following step S14 regardless of its format.

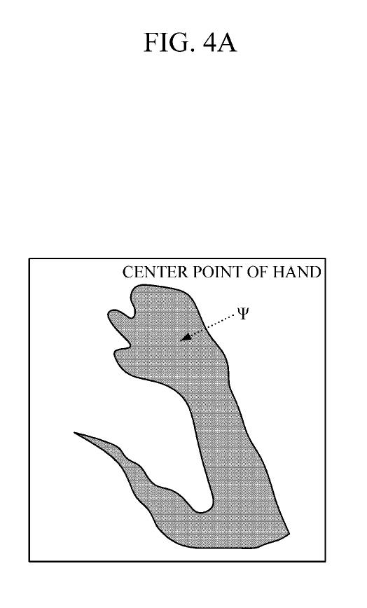

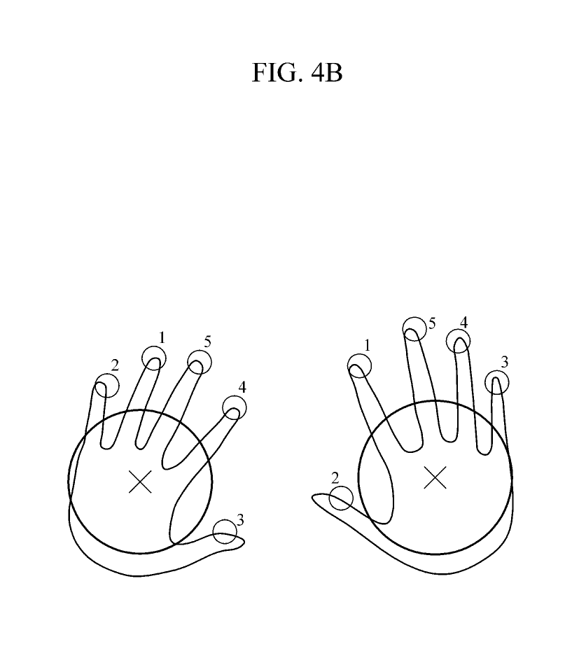

Subsequently, the IoMTW system, for example, the wearable electronic device or the processing unit finds a hand movement path from the hand area sequence obtained in step S11 (S13). In more detail, the wearable electronic device or the processing unit finds a position of the hand on the basis of the hand area detected from each frame. A position of the hand may be, for example, a position of a center point of the hand in a screen and may be found using a predetermined specific point of the hand or the palm. FIG. 4A shows an example in which a predetermined specific point Ψ is used as a center point of a hand. Unlike this, the center point of the hand may also be found using a direction vector of each finger. FIG. 4B shows an example in which a circle with a predetermined radius is formed using a point at which the direction vectors of the fingers meet and the center of the circle is used as the center point of the hand.

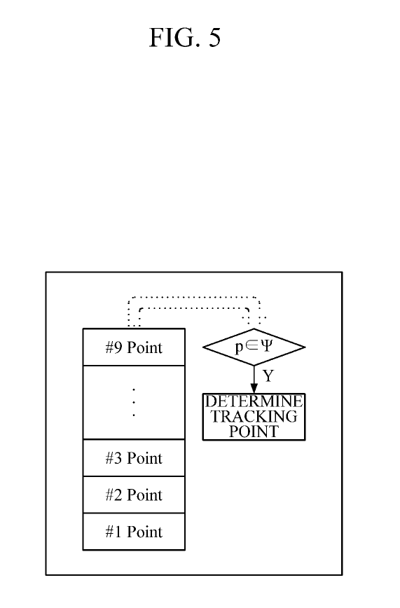

Also, the wearable electronic device or the processing unit may find a movement path of the center point of the hand, that is, a hand trajectory for each frame. To this end, there is a need for position information of the center points of the plurality of frames. Accordingly, hand position information for each frame may be managed in the form of a queue. FIG. 5 schematically shows an example in which hand position information is managed in the form of a queue. Referring to FIG. 5, it can be seen that when the position information (#n point) of the hand stored in the queue is the center point (p∈Ψ), the center point is determined as a tracking point, and a hand movement path is found using the tracking point. The found movement path may be represented as hand trajectory information. The hand trajectory information may be utilized as information for recognizing a hand gesture in the following step S14 regardless of its format.

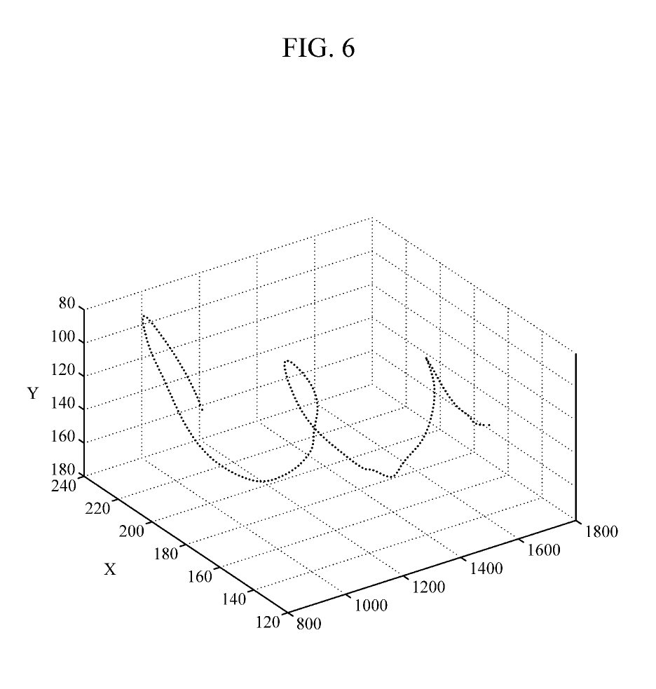

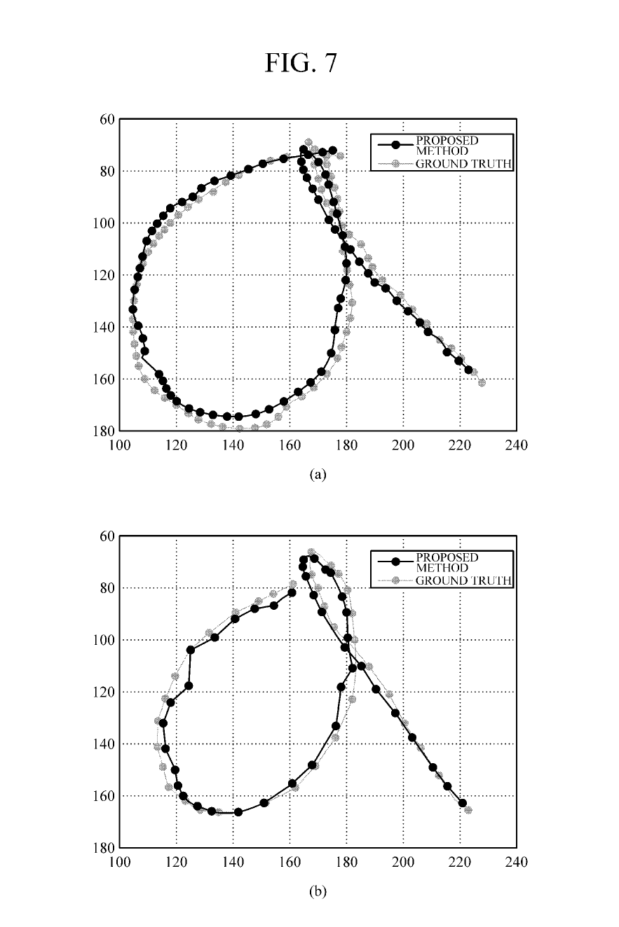

Typically, when the hand movement path is found, an average hand movement speed as well as a movement distance may be found. For example, the hand movement distance may be found by calculating a length of a figure represented by the hand trajectory, for example, a three-dimensional curve segment or straight line segment. FIG. 6 shows an example of a hand trajectory that is expressed using a three-dimensional curve. The average hand movement speed may be found by dividing the hand movement distance by a movement time. FIG. 7 shows hand trajectories at different average hand movement speeds. FIG. 7A shows a case in which an average hand movement speed is low. FIG. 7B shows a case in which an average hand movement speed is high. Referring to FIG. 7, it can be seen that distances between points indicating the hand trajectory are relatively small as shown in FIG. 7A and relatively large as shown in FIG. 7B.

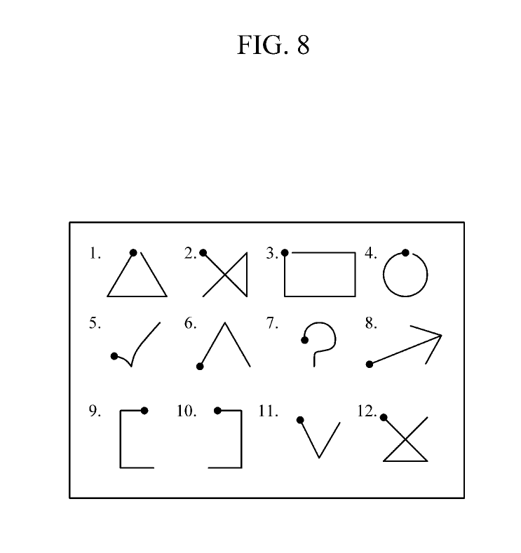

According to an embodiment of the present invention, not all hand trajectories are caused by movement of the hand, only hand trajectories having movement distances and/or average movement speeds that satisfy a predetermined condition may be regarded as being caused by movement of the hand. For example, it is assumed that a hand trajectory is found on the basis of recent N image frames. Only when a relative hand movement distance is greater than or equal to a first reference M and an average hand movement speed is greater than or equal to a second reference V, the hand movement may be regarded as being generated. Accordingly, a final movement path may be found in combination of recognized hand movements. FIG. 8 is a diagram schematically showing various hand trajectories.

Referring to FIG. 2 again, the IoMTW system, for example, the wearable electronic device or the processing unit recognizes a hand gesture using hand contour information and hand trajectory information (S14). The recognition of the hand gesture is a process of checking which gesture command is indicated by a hand shape and a hand movement path that are detected. That is, according to this embodiment, a hand gesture is recognized by considering both of the hand contour information found in step S12 and the hand trajectory information found in step S13. Also, the IoMTW system finds a gesture command corresponding to the recognized hand gesture and outputs the gesture command.

In order to recognize the hand gesture, the processing unit may check a corresponding hand shape by comparing the received hand contour information with specific hand shapes that are pre-registered in a database. In this case, the information regarding direction vectors of the hand shapes used to recognize the hand gesture may be stored in the database. The processing unit may calculate similarities between a finger direction vector indicating the hand contour information generated in step S12 and the direction vectors stored in the database and may recognize a hand shape corresponding to the most similar direction vector. In order to recognize the hand gesture, the processing unit may check a corresponding hand shape by comparing the received hand contour information with specific hand shapes that are pre-registered in the database.

Referring to FIG. 2, the IoMTW system, for example, the wearable electronic device or the processing unit controls the wearable electronic device according to the gesture command output in step S14 (S15). For example, the IoMTW system may control the wearable electronic device to start, stop, or pause playing multimedia content according to the gesture command. Alternatively, the IoMTW system may adjust volume or screen brightness/color or change multimedia content that is being played according to the gesture command.

A hand gesture command processing apparatus that may be implemented in the IoMTW system of FIG. 1 will be described below.

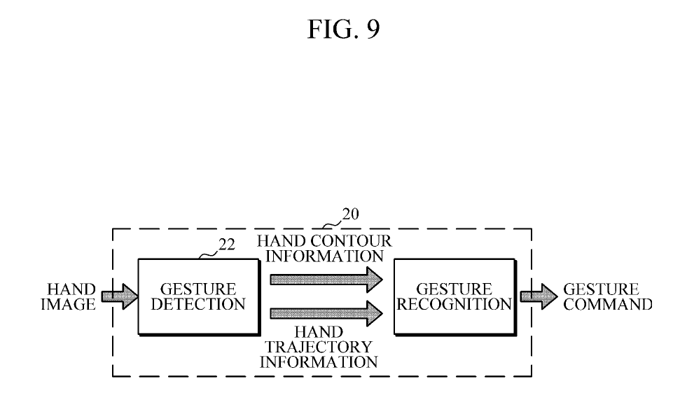

FIG. 9 is a block diagram showing a schematic configuration of an apparatus for processing a hand gesture command for a media-centric wearable electronic device according to an embodiment of the present invention. The hand gesture command processing apparatus 20 shown in FIG. 9 may be a functional block included in the IoMTW system shown in FIG. 1. There are no restrictions on elements included in the functional block. For example, a gesture detection module 22 and a gesture recognition module 24 may be separated from the wearable electronic device and the processing unit that constitute the IoMTW system or may be included in any one of the wearable electronic device and the processing unit. In particular, in the former case, the gesture detection module 22 and the gesture recognition module 24 may be present in different devices or on difference spaces.

Also, the hand gesture command processing apparatus 20 shown in FIG. 9 is an example of an apparatus for performing the hand gesture command processing method that has been described with reference to FIGS. 2 to 8. Accordingly, in order to avoid redundant description, operations or functions of the hand gesture command processing apparatus 20 and its functional blocks will be simply described below. Also, unless explicitly described to the contrary in this specification, the above-description with reference to FIGS. 2 to 8 may be applied to parts that are not described in detail in association with the hand gesture command processing apparatus 20.

Referring to FIG. 9, the hand gesture command processing apparatus 20 includes the gesture detection module 22 and the gesture recognition module 24. The gesture detection module 22 detects a hand shape from a hand image that is input and outputs hand contour information. Also, the gesture detection module 22 detects a hand movement path and outputs hand trajectory information. Also, the gesture recognition module 24 outputs a gesture command for controlling the wearable electronic device using the hand contour information and the hand trajectory information. This is simply summarized as the following Table 1.

TABLE 1

| Module | Information | Reference |
|---|---|---|
| Hand Detection | Hand Contour | Module for generating contour |
| | Information | information and trajectory |
| | Hand Trajectory | information through detection of |
| | Information | hand for each frame in units of an |
| | | image frame. |
| Hand | Gesture Command | Module for recognizing command |
| Recognition | | generated by hand gesture of user |
| | | using contour information and |
| | | trajectory information |

According to an aspect, a hand detection module may generate hand contour information and hand trajectory information in response to a hand gesture event (that is, a sequence of hand images) of a user and may deliver the generated hand contour information and hand trajectory information to a hand recognition module. Logically, this means that after the hand gesture event, all data is summarized and then the hand contour information and the hand trajectory information are generated and delivered. The performance of the hand detection module should be excellent to perform the above process in real time. However, the performance of the hand recognition module should also be considerable because the hand recognition module receives information after a corresponding event ends.

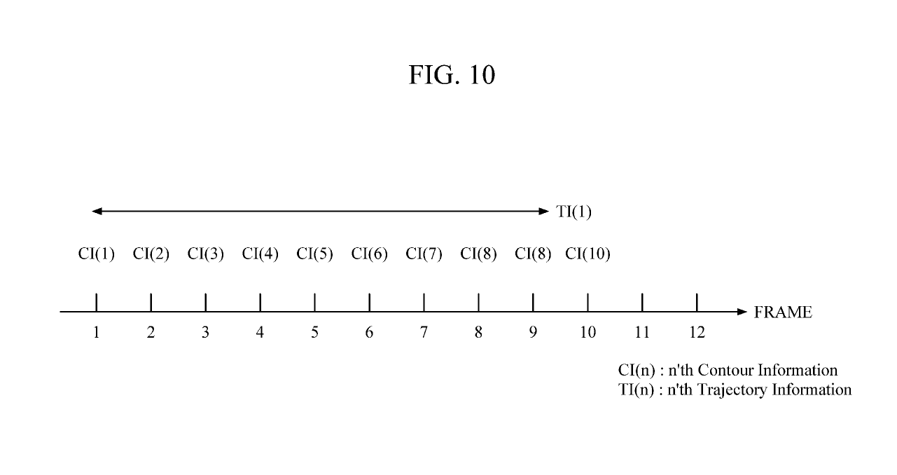

According to another aspect, when the typical performance of the hand detection module and the hand recognition module are considered, the hand detection module may generate hand contour information for each frame and deliver the generated hand contour information to the hand recognition module so that the hand recognition module may generate a gesture command in real time. Also, the hand recognition module should be ready to process the information. FIG. 10 schematically shows an example of a processing process of a hand detection module and a hand recognition module. Referring to FIG. 10, it can be seen that the hand detection module generates and delivers hand contour information CI(n) in units of a frame and also generates and delivers only one piece of the hand trajectory information TI(n) for the plurality of frames.

There are several prerequisites for the hand gesture command processing apparatus 20 to include the gesture detection module 22 and the gesture recognition module 24. Table 2 below shows four essential conditions among the prerequisites. However, the prerequisites may be changed in the future, and some of them may be eased or unnecessary.

TABLE 2

| | Item | Condition |
|---|---|---|
| 1 | Camera | This is a unique characteristic of a camera, which is |
| | Frame | the number of consecutive image frames per second, |
| | Rate | and corresponds to an absolute time interval between |
| | | frames. The time interval between frames is physically |
| | | constant and typically has a value of 24 Hz to 60 Hz. |
| | | 24 Hz refers to consecutive and independent 24 |
| | | images per second and has an interval of 41.6 msec. |
| | | Thus, the absolute time interval between hand center |
| | | points is constant. |
| | | * Frame_Interval_Time = 1/Frame_Rate |
| 2 | Hand | This indicates the number of hands that are present |
| | Number | in an image frame. Hand detection may be performed |
| | | several times. However, for the purpose of quick |
| | | detection, it is assumed that there is one hand. The |
| | | detected hand may be expressed as a set of n Bezier |
| | | curves. |
| 3 | Space | This indicates a space where a hand moves. A hand |
| | | may move three-dimensionally along an X axis and |
| | | Y axis as well as a Z axis. However, for the purpose |
| | | of quick detection, there is motion in only a 2D space |
| | | composed of the X axis and Y axis, and the motion |
| | | may be represented as a set of n Bezier curves. In |
| | | this case, the 3D space may be expressed by projec- |
| | | tion into the 2D space. |
| 4 | Time | Only when a hand moves an appropriate distance at |
| | | a predetermined speed, can the movement be ex- |
| | | pressed as a valid curve. Thus, there is no restric- |
| | | tion on the minimum time required to detect hand |
| | | motion. For example, motion that moves in a |
| | | horizontal direction of screen can be determined |
| | | as a valid trajectory when there are about 12 center |
| | | points. Accordingly, for a 24 Hz camera, 41.6 msec*12 = |
| | | 500 msec. That is, time required to detect horizontal |
| | | motion is limited to 0.5 sec or greater. |

Under the above-described prerequisites, the gesture detection module 22 may configure hand trajectory information in various methods for a predetermined time. That is, the gesture detection module 22 may divide the entire hand trajectory into hand trajectory segments in various methods, express each of the hand trajectory segments as its corresponding hand trajectory information, and deliver the hand trajectory information to the gesture recognition module 24. In this case, the gesture recognition module 24 may parse the delivered hand trajectory information (corresponding to the hand trajectory segment) to find a hand trajectory. Accordingly, the gesture detection module 22 may have an enhanced processing speed, compared to a case in which the entire hand trajectory is expressed as single hand trajectory information.

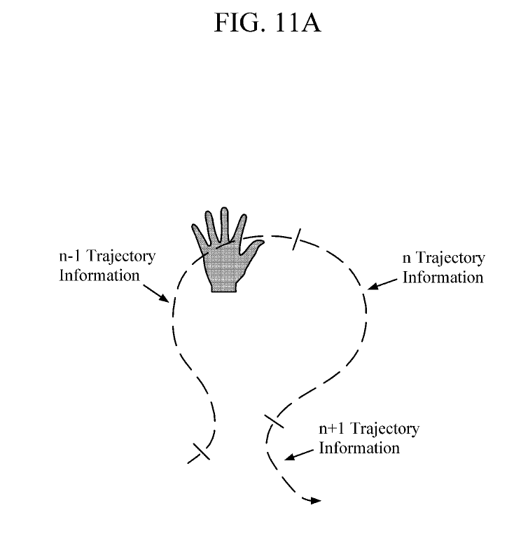

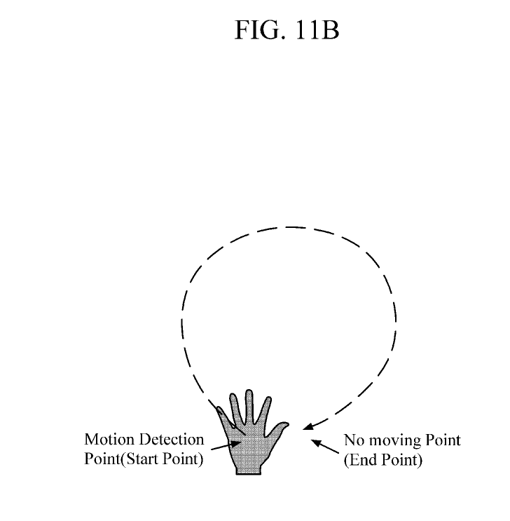

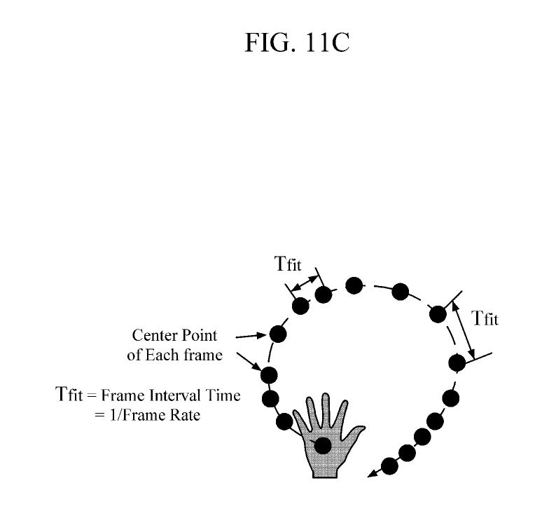

FIGS. 11A to 11C are diagrams schematically showing examples of a method of configuring a hand trajectory. In more detail, FIG. 11A is an example of configuring a hand trajectory in a time division method, FIG. 11B is an example of configuring a hand trajectory in a motion division method, and FIG. 11C is an example of configuring a hand trajectory in a point division method.

Referring to FIG. 11A, according to the time division method, the gesture detection module 22 divides the entire time into a plurality of time sections and generates and delivers trajectory information during any time section. In this case, the entire trajectory information is divided into n−1^{th} trajectory information, n^{th} trajectory information, and n+1^{th} trajectory information. Also, the gesture recognition module 24 recognizes a hand gesture in combination of the nth trajectory information and also its preceding and following trajectory information. To this end, the gesture recognition module 24 may recognize the hand gesture in consideration of continuity or interoperability between the preceding and following trajectory information.

Referring to FIG. 11B, according to the motion division method, the gesture detection module 22 generates hand trajectory information including segment motion information that is obtained through divisional motion sensing, that is, motion detection and delivers the generated hand trajectory information. In this case, the entire trajectory information may have a plurality of pieces of segment motion information. Also, the gesture recognition module 24 recognizes a hand gesture on the basis of valid pieces of the segment motion information. To this end, additionally, the gesture recognition module 24 may need a function of determining whether a valid hand motion is generated.

Referring to FIG. 11C, according to the point division method, the gesture detection module 22 includes information regarding a specific point of a hand, for example, the center of a hand in each piece of the frame information as the hand trajectory information and may deliver the frame information. Strictly, it is hard to say that the information regarding a specific point of a hand is the hand trajectory information. However, since the gesture recognition module 24 can reconstruct the hand trajectory information using information regarding a plurality of specific points of a hand, the information regarding a specific point of a hand may be referred to as the hand trajectory information. To this end, additionally, the gesture recognition module 24 may need a function of reconstructing the hand trajectory information using the information regarding a plurality of points.

The above-described three hand trajectory information configuration methods may be summarized as the following Table 3.

TABLE 3

| | | Parsing Method in Gesture |
|---|---|---|
| | Configuration Method | Recognition Module |
| 1 | Time Division: | Match corresponding gesture |
| | Method of delivering | command in consideration of |
| | trajectory information | continuity and interoperability |
| | for any time | of preceding or following |
| | | trajectory information |
| | | → Generate a plurality of pieces |
| | | of segment trajectory information |
| | | in units of absolute time |
| | | interval |
| 2 | Motion Division: | Match corresponding gesture |
| | Method of delivering | command based on valid hand |
| | valid trajectory infor- | motion in delivered trajectory |
| | mation including | information |
| | gesture command through | → Need a function of |
| | motion sensing such | determining whether valid |
| | as motion detection | hand motion is generated |
| 3 | Point Division: | Match corresponding gesture |
| | Method of delivering | command by reconfiguring hand |
| | frame information including | trajectory using hand center |
| | hand center point of | point information every frame |
| | trajectory information | |

Under the above-described prerequisites described in Table 2, the gesture detection module 22 may configure the hand contour information in various methods. For example, the gesture detection module 22 may detect a contour of a hand every frame or at predetermined frame intervals and may generate and deliver the hand contour information. Alternatively, the gesture detection module 22 may minimize the generation of the hand contour information when it is determined that the contour is unchanged during a certain condition and the condition is kept satisfied. For example, the hand contour information may be generated once every time division unit, as shown in FIG. 11A, and may be generated once every motion division unit, as shown in FIG. 11B.

The above-described hand trajectory information and hand contour information may be expressed as metadata having a predetermined format. The following Table 4 and Table 5 show example methods of describing the hand contour information and the hand trajectory information, respectively.

TABLE 4

| Parameter | Default | Reference | Size |
|---|---|---|---|
| Raw Format | Bezier Curve | 1. Trajectory Information (as Bezier Curve) | 8 bit |
| | | 2. Sequence Information (as Table) | |
| Bezier Curve | 3rd (Cubic | 2nd: “Quadratic” | 8 bit |
| Order | Bezier Curve) | 3rd: “Cubic” | |
| Bezier Curve | n'th Bezier | N: Bezier Curve Point Number | 16 bit |
| Point Number | Curve Point | Total Point Number: 3*N | |
| | Pn, Cn0, | n: Bezier Curve Point Index | |
| | Cn1, Pn + 1 | Pn, Pn + 1: Bezier Start &End Point | |
| | | Cn0, Cn1: Control Point | |
| Bezier Curve | | Max Error Value for the each Bezier Curve | 16 bit |
| Error Range | | Generation | |
| Frame | Index | 16 bit Incremental Counter: | 16 bit |
| Incremental | | When the counter reach the max, it should return | |
| Counter | | to zero by rolling over. | |
| Image Frame | Frame Rate: (Hz) | FR (Frame Rate): | 8 bit |
| Rate | Frame Number | frame image number during one second | |
| | | 24 or 30 Hz or ? | |
| | | Frame Time Interval = 1/Fn | |
| Number of | P0 C00 C01 | { (Px0, Py0), (Cx00, Cy00), (Cx01, Cy01) }, | |
| Pointer | P1 C10 C11 | { (Px1, Py1), (Cx10, Cy10), (Cx11, Cy11) }, | |
| | . . . | | |
| | Pn − 1 C10 C11 | | |

TABLE 5

| Parameter | Default | Reference | Size |
|---|---|---|---|
| Raw Format | Bezier Curve | 1. Contour Information (as Bezier Curve) | 8 bit |
| Mode | | 2. Raw Image (as BMP) | |
| | | 3. Compressed Image (as JPEG) | |
| Bezier Curve | 3rd (Cubic | 2nd: “Quadratic” | 8 bit |
| Order | Bezier Curve) | 3rd: “Cubic” | |
| Bezier Curve | | 1. Use Current Contour (Bezier Curve Group) | 8 bit |
| Group | | 2. Use Last Available Contour (Bezier Curve | |
| Available | | Group) | |
| Bezier Curve | n'th Bezier | N: Bezier Curve Point Number | 16 bit |
| Point Number | Curve Point | Total Point Number: 3*N | |
| | Pn, Cn0, | n: Bezier Curve Point Index | |
| | Cn1, Pn + 1 | Pn, Pn + 1: Bezier Start &End Point | |
| | | Cn0, Cn1: Control Point | |
| Frame | Index | 16-bit adder (Incremental Counter): | 16 bit |
| Incremental | | When the counter reach the max, it should | |
| Counter | | return to zero by rolling over. | |
| Trajectory | | 1. Time Divison | 8 bit |
| Transferring | | 2. Motion Divison | |
| Method | | 3. Point Divison | |
| | | * The following parameters are inclusive only | |
| | | for Point Division | |
| Image Frame | Frame Rate: (Hz) | FR (Frame Rate): | 8 bit |
| Rate | Frame Number | frame image number during 1 second | |
| | | 24 or 30 Hz or ? | |
| | | Frame Time Interval = 1/Fn | |
| Center X | | The centroid X axis point of Bezier Curve Group | |
| Center Y | | The centroid Y axis point of Bezier Curve Group | 16 bit |
| Number of | P0 C00 C01 | { (Px0, Py0), (Cx00, Cy00), (Cx01, Cy01) }, | |
| Pointer | P1 C10 C11 | { (Px1, Py1), (Cx10, Cy10), (Cx11, Cy11) }, | |
| | . . . | | |
| | Pn − 1 C10 C11 | | |

Metadata for a media-centric wearable device will be described below. The metadata is needed for a user to receive a result value when the user enters specific information or signals using a wearable device. Accordingly, the metadata is used to exchange information between elements in the IoMTW system shown in FIG. 1. For example, the metadata may be utilized to control the media wearable electronic device MWearable to consume multimedia content.

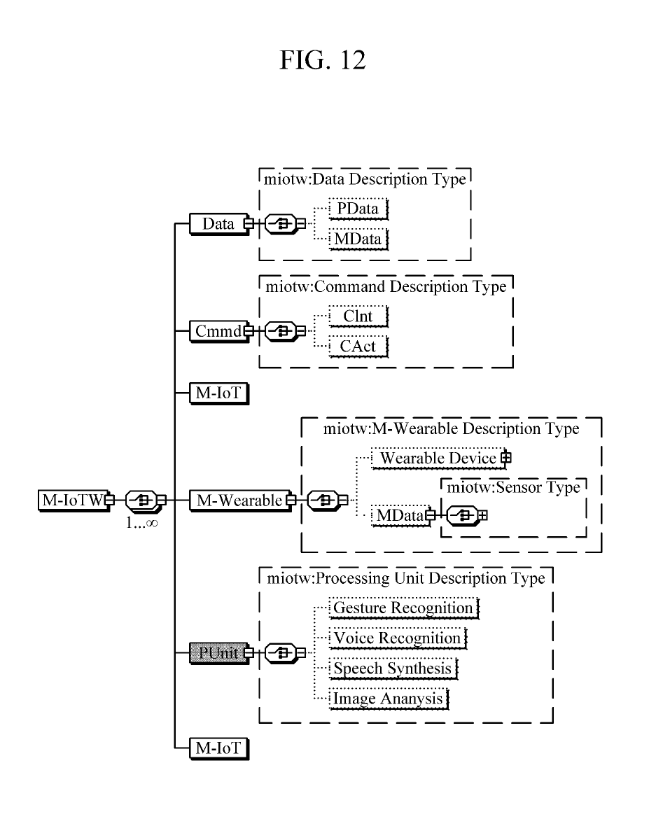

FIG. 12 is a diagram showing a description structure of metadata for a media-centric wearable device. Referring to FIG. 12, the metadata for a media-centric wearable device is a top-level description element (i.e., a root element) and is classified into 6 types. In more detail, the top level description element includes a data element Data, a command element Cmmd, a media-centric Internet of things element M-IoT, a media-centric wearable element M-Wearable, a processing element PUnit, and a user element User. According to an aspect of this embodiment, the top-level description elements do not need to be generated at the same time and may be generated as needed. Also, there is no need for the same top level description element to be one. A plurality of the same top level description elements may be generated if necessary.

The data element Data is a sub-description element and is composed of processing data PData and a media data MData. The processing data PData is data input for processing and is used to express input information that is input through an input device of a wearable device and information that is generated during the processing. A representative example of the input information is video data or voice data that is input from a user. A control signal for controlling the wearable device may be generated by processing the processing data PData by the IoMTW system. The media data MData is used to express media data provided to a user and may include, for example, video data, voice data, text data, graphic data, etc.

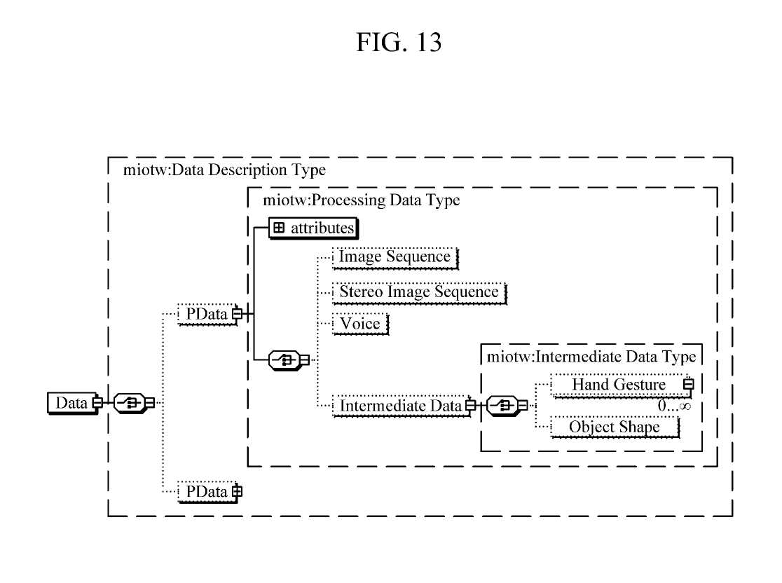

FIG. 13 is a diagram showing a configuration of a data element Data in detail. As described above, the data element Data is composed of the processing data PData and the media data MData. The processing data PData includes various types of data, for example, an image sequence ImageSequence, a stereo image sequence StereoImageSequence, voice Voice, etc. as well as attributes.

The processing data includes intermediate data IntermediateData that is generated by processing such data as a separate type. For example, the intermediate data IntermediateData may include types such as hand gesture data HandGesture and object shape data ObjectShape.

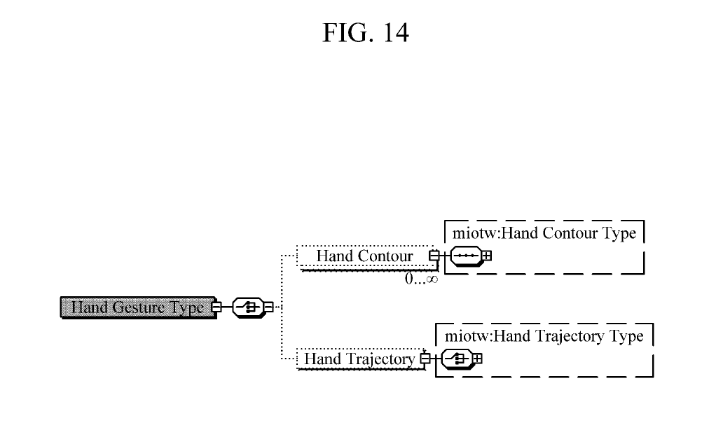

FIG. 14 is a diagram showing an example of a configuration of a hand gesture data type HandGestureType. Referring to FIG. 14, the hand gesture data type HandGestureType may include types such as hand contour data and hand trajectory data.

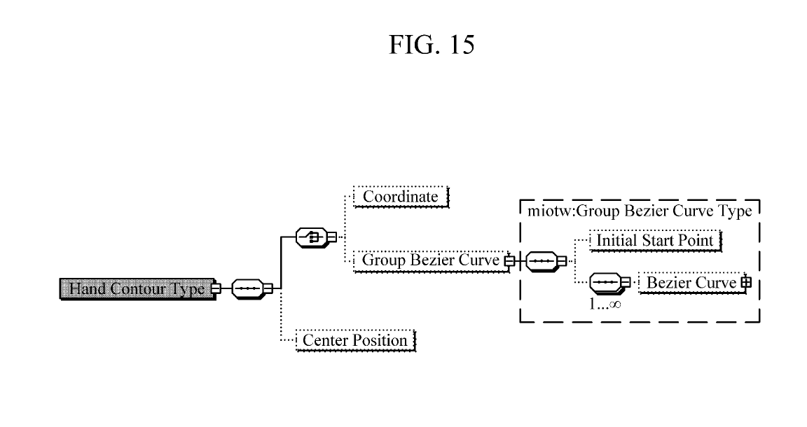

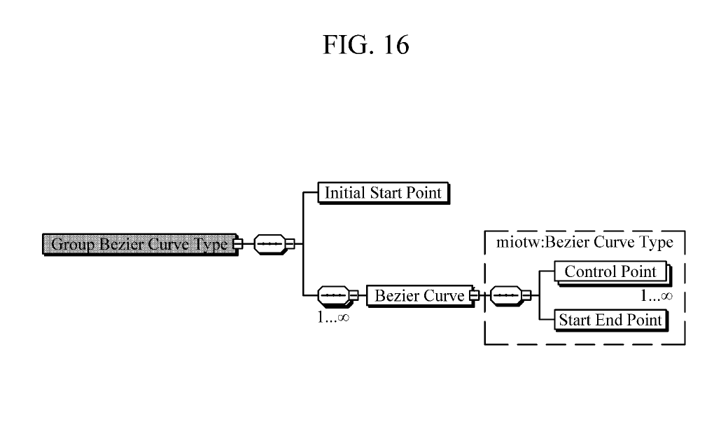

FIG. 15 is a diagram showing an example of a configuration of a hand contour data type HandContourType. Referring to FIG. 15, the hand contour data type HandContourType includes a type such as center position data CenterPosition in addition to types such as coordinate data Coordinate and group Bezier curve data GroupBezierCurve. FIG. 16 is a diagram showing an example of a detailed configuration of a group Bezier curve data type GroupBezierCurveType and includes Bezier curve data BezierCurve composed of control point data ControlPoint and start and end point data StartEndPoint in addition to initial start point data InitialStartPoint.

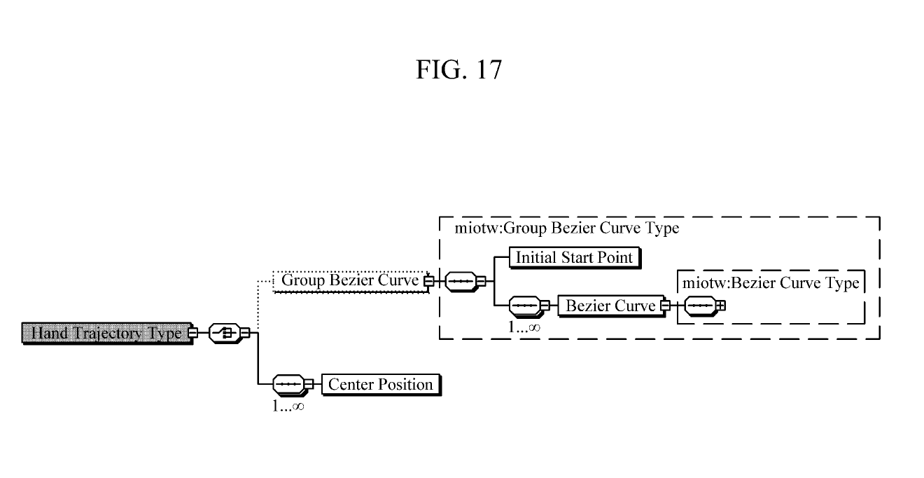

FIG. 17 is a diagram showing an example of a configuration of a hand trajectory data type HandTrajectoryType in the configuration of FIG. 14. Referring to FIG. 17, the hand trajectory data type HandTrajectoryType includes group Bezier curve data GroupBezierCurve and center position data CenterPosition. Also, the group Bezier curve data GroupBezierCurve includes start and end point data StartEndPoint and Bezier curve data BezierCurve.

Referring to FIG. 12 again, the command element Cmmd includes an interaction command CInt and an action command CAct. The interaction command CInt describes control information between a user and a wearable device or between a wearable device and a processing unit. Also, the action command CAct describes control information for controlling an M-IoT device such as a sensor that is connected with the wearable device or a media-centric wearable electronic device M-Wearable.

The media-centric wearable element M-Wearable includes a wearable device element WearableDevice and a sensor element Sensor. The media-centric wearable element M-Wearable describes information about a wearable device and information about an input/output device or sensor that is installed in the wearable device. Also, a processing unit element PUnit provides a description structure for describing useful information for processing input information and controlling the wearable device and the media or information on processing for generating a command. The processing unit element PUnit may be classified into types such as gesture recognition GestureRecognition, voice recognition VoiceRecognition, voice synthesis SpeechSynthesis, and image analysis ImageAnalysis. Also, the user element User provides a description structure for describing information regarding a user who uses the wearable device.

According to an embodiment of the present invention, in an IoMTW system, it is possible to detect and recognize a hand gesture of a user to control a wearable electronic device. Thus, the user can consume multimedia content without physically holding the wearable electronic device. Also, various types of metadata needed for operation of an IoMTW system may be efficiently described.

The above-description is merely an example embodiment, and the present invention should not be construed as being limited to the embodiment. Therefore, the technical spirit of the invention is defined only by the appended claims, and any technical spirit within their legal equivalents should be construed as being included in the scope of the invention. Accordingly, it will be obvious to those skilled in the art that various modifications of the above-described embodiments can be made.

What is claimed is:

1. A method of processing a hand gesture command for a media-centric wearable electronic device in an Internet of Media Things and Wearables (IoMTW) system, the method comprising:
acquiring a hand image of a user' hand;
distinguishing a background area and a hand area in the acquired hand image;
detecting a hand shape using the distinguished hand area and generating hand contour information describing the detected hand shape;
detecting a hand movement path based on a change of the distinguished hand area over time and generating hand trajectory information describing the detected hand movement path; and
recognizing a hand gesture of the user using the hand contour information and the hand trajectory information.

2. The method of claim 1, wherein the hand contour information is expressed as a set of coordinates indicating a plurality of points corresponding to a contour of the detected hand shape or a set of direction vectors of a plurality of fingers constituting the hand.

3. The method of claim 1, wherein the generating of hand contour information comprises generating the hand contour information only when a movement distance or average movement speed of the hand is greater than or equal to a predetermined reference.

4. The method of claim 1, wherein the hand trajectory information includes the hand movement path configured in a time division method, a motion division method, or a point division method.

5. The method of claim 1, wherein:
metadata for the media-centric wearable electronic device is composed of a data element, a command element, a media-centric Internet of things (IoT) element, a media-centric wearable element, a processing element, and a user element as top level description elements; and
the hand contour information and the hand trajectory information are included in processing data of the data element.

6. The method of claim 5, wherein the top level description elements are generated as needed, and a plurality of the same elements are allowed to be generated.

7. An apparatus for processing a hand gesture command for a media-centric wearable electronic device in an Internet of Media Things and Wearables (IoMTW) system, the apparatus comprising:
a gesture detection unit configured to distinguish a background area and a hand area in a hand image of a user that is input, detect a hand shape using the distinguished hand area, generate hand contour information describing the detected hand shape, detect a hand movement path based on a change of the distinguished hand area over time, and generate hand trajectory information describing the detected hand movement path; and
a gesture recognition unit configured to recognize a hand gesture of the user using the hand contour information and the hand trajectory information delivered from the gesture detection unit.

8. The apparatus of claim 7, wherein:
the hand contour information is expressed as a set of coordinates indicating a plurality of points corresponding to a contour of the detected hand shape or a set of direction vectors of a plurality of fingers constituting the hand; and
the hand trajectory information has the hand movement path configured in a time division method, a motion division method, or a point division method.
